(19) United States
(12) Patent Application Publication
(10) Pub. No.: US 2012/0148739 A1
(43) Pub. Date: Jun. 14, 2012

(54) METHOD FOR MANUFACTURING METAL NANOSTRUCTURE AND METAL NANOSTRUCTURE MANUFACTURED BY THE METHOD

(75) Inventors: Ick Soo KIM, Nagano (JP); Jae Hwan LEE, Gyeongbuk (KR); Byoung-Suhk KIM, Nagano (JP); Kei WATANABE, Nagano (JP); Naotaka KIMURA, Nagano (JP); Hae-Rim KIM, Nagano (JP); Hyun-Sik BANG, Nagano (JP)

(73) Assignees: SHINSHU UNIVERSITY, Nagano (JP); TOPTEC CO., LTD., Gyeongbuk (KR)

(21) Appl. No.: 12/963,764

(22) Filed: Dec. 9, 2010

(51) Int. Cl. B05D 3/02; B29C 47/00; B82Y 40/00

(52) U.S. Cl. 427/212; 264/464; 977/888; 977/890; 977/891

(57) ABSTRACT

A method for manufacturing metal nanostructure which can manufacture a metal nanostructure which has the structure and properties different from the structure and properties of a conventional material and can be properly used in various applications is provided. The method for manufacturing metal nanostructure includes the steps of: preparing metal-coated organic nanofibers in which surfaces of the organic nanofibers are coated with metal; and preparing a metal nanostructure having the structure where the organic nanofibers are used as a template by removing organic components from the metal-coated organic nanofibers by heating the metal-coated organic nanofibers at a temperature ranging from 250° C. to 600° C.

### BACKGROUND OF THE INVENTION

1. Field of the Invention

The present invention relates to a method for manufacturing metal nanostructure and a metal nanostructure manufactured by the method.

2. Description of the Related Art

Conventionally, there has been known a method for manufacturing metal-coated organic nanofibers in which metal-coated organic nanofibers are manufactured by coating surfaces of organic nanofibers with metal (see JP-A-2010-65327, for example).

According to the conventional method for manufacturing metal-coated organic nanofibers, it is possible to manufacture metal-coated organic nanofibers which possess air permeability, waterproof property, moisture retention, flexibility in a balanced manner and are properly applicable to various usages (for example, winter clothes, ski wear, other kinds of clothing, electromagnetic wave shielding material, an electromagnetic wave absorbing material and the like).

### SUMMARY OF THE INVENTION

In industry, there has been a steady demand for a material which can be properly used in various applications and which possesses properties and structures different from the properties and structures of conventional materials, and a method which can manufacture such a material.

The present invention has been made under such circumstances, and it is an object of the present invention to provide a material which has the structure and properties different from the structure and properties of a conventional material and can be properly used in various applications, and a method which can manufacture such a material.

[1] According to one aspect of the present invention, there is provided a method for manufacturing metal nanostructure including the steps of: preparing metal-coated organic nanofibers in which surfaces of the organic nanofibers are coated with metal; and preparing a metal nanostructure having the structure where the organic nanofibers are used as a template by removing organic components from the metal-coated organic nanofibers by heating the metal-coated organic nanofibers at a temperature ranging from 250° C. to 600° C.

According to the method for manufacturing metal nanostructure of the present invention, the metal nanostructure has the structure where the organic nanofibers are used as the template, that is, has the structure which does not exist conventionally and hence, it is possible to manufacture the metal nanostructure having properties different from properties of conventional materials.

The metal nanostructure preparation step may be performed in an inert-gas atmosphere, an oxidizing atmosphere or a reducing atmosphere. In any of these atmospheres, the organic component in the organic nanofibers is removed by thermal decomposition. Here, metal which is present on the periphery of the organic nanofibers remains as it is. Further, by properly selecting the atmosphere, it is possible to manufacture various kinds of metal nanostructures having properties different from conventional materials.

The metal nanostructure manufactured by the method for manufacturing metal nanostructure of the present invention is broadly applicable to fields such as various electronic/mechanical material fields (a semiconductor material, an OLED material, an LED material, a nano-chemical sensor material, an MEMS material, an FED material, a battery material such as a carrier of a fuel battery catalyst, an electromagnetic wave shield material, a bimetal thermocouple material, a high-speed transistor material, a hydrogen gas storage material, a power storage device material, a transparent electrically conductive material, an electrically conductive paste material, a magnetic material for a sensor, a memory or the like), a medical field material (a carrier of a biological sensor, a biomedical material, a medical MEMS, a medical micro robot, a regeneration medicine material or the like) or the like.

The metal nanostructure of the present invention includes not only the metal nanostructure made of metal but also a metal nanostructure made of metal oxide, a metal nanostructure made of metal nitride and other metal nanostructures.

[2] In the method for manufacturing metal nanostructure of the present invention, the step of preparing the metal-coated organic nanofibers may preferably include the steps of: preparing the organic nanofibers by electrospinning; and coating surfaces of the organic nanofibers with metal in this order.

By adopting such a method, it is possible to manufacture an extremely fine metal nanostructure (eventually having an extremely large surface area and an extremely large aspect ratio) using extremely fine organic nanofibers formed by electrospinning as the template. As the metal nanostructure which can be manufactured by the method, for example, metal nanotubes, metal nanochains and the like can be exemplified.

[3] In the method for manufacturing metal nanostructure of the present invention, in the step of coating the surfaces of the organic nanofibers with the metal, the metal may preferably be vapor-deposited on the surfaces of the organic nanofibers.

By adopting such a method, it is possible to coat the surfaces of the organic nanofibers with various metals using a-well-known metal vapor deposition technique.

[4] In the method for manufacturing metal nanostructure of the present invention, in the step of coating the surfaces of the organic nanofibers with the metal, the metal may preferably be vapor-deposited on both surfaces of an organic nanofiber nonwoven fabric made of the organic nanofibers.

By adopting such a method, compared to a case where metal is vapor-deposited on one surface of the organic nanofiber nonwoven fabric, a rate of portions to which metal is not vapor-deposited with respect to the whole organic nanofibers can be decreased and hence, it is possible to continuously and uniformly coat the surfaces of the organic nanofibers with metal.

[5] In the method for manufacturing metal nanostructure of the present invention, a thickness of the organic nanofiber nonwoven fabric may preferably be 100 μm or less.

By adopting such a method, compared to a case where the thickness of the organic nanofiber nonwoven fabric exceeds 100 μm, a rate of portions to which metal is not vapor-deposited with respect to the whole organic nanofibers can be decreased and hence, it is possible to continuously and uniformly coat with metal the surfaces of most of the organic nanofibers which constitute the organic nanofiber nonwoven fabric. In this respect, it is desirable that the thickness of the organic nanofiber nonwoven fabric is less than 30 μm, or more preferably, less than 10 μm.

[6] In the method for manufacturing metal nanostructure of the present invention, an average diameter of the organic nanofibers may preferably be 1000 nm or less.

By adopting such a method, compared to a case where the average diameter of the organic nanofibers exceeds 1000 nm, an area of portions of the organic nanofibers to which metal is not vapor-deposited can be decreased and hence, it is possible to continuously and uniformly coat the surfaces of the organic nanofibers with metal. In this respect, it is desirable that the thickness of the organic nanofiber nonwoven fabric is less than 800 nm, or more preferably, less than 500 nm.

[7] In the method for manufacturing metal nanostructure of the present invention, the organic nanofibers may preferably be formed of organic nanofibers each of which contains carbon nanotubes (also referred to as CNT hereinafter) in the inside thereof or on a surface thereof.

By adopting such a method, the metal nanostructure has the structure where CNT is adhered to inner surfaces so that it is possible to manufacture the metal nanostructure which possesses properties further different from properties of conventional materials.

[8] In the method for manufacturing metal nanostructure of the present invention, the organic nanofibers may preferably be formed of organic nanofibers having surfaces to which CNT are adhered.

Also by adopting such a method, the metal nanostructure has the structure where CNT is adhered to inner surfaces so that it is possible to manufacture the metal nanostructure which possesses properties further different from properties of conventional materials.

[9] According to another aspect of the present invention, there is provided a metal nanostructure manufactured by the method for manufacturing metal nanostructure of the present invention, wherein the metal nanostructure is formed of metal nanotubes or metal nanochains.

The metal nanostructure of the present invention has the structure where the organic nanofibers are used as the template, that is, has the structure which does not exist conventionally and hence, it is possible to manufacture the metal nanostructure having properties different from properties of conventional materials.

[10] According to still another aspect of the present invention, there is provided a metal nanostructure which is the metal nanostructure manufactured by the method for manufacturing metal nanostructure of the present invention, wherein the metal nanostructure is formed of metal nanotubes or metal nanochains, and CNT are adhered to inner surfaces of the metal nanotubes or inner surfaces of the metal nanochains.

The metal nanostructure of the present invention has the structure where the organic nanofibers are used as the template and CNT is adhered to inner surfaces and hence, it is possible to manufacture the metal nanostructure having properties different from properties of conventional materials.

### BRIEF DESCRIPTION OF THE DRAWINGS

FIG. 1 is a flowchart for explaining a method for manufacturing metal nanostructure according to an embodiment 1;

FIG. 2 is a view for explaining an organic nanofiber preparation step according to the embodiment 1;

FIG. 3 is a view for explaining a metal coating step according to the embodiment 1;

FIG. 4A to FIG. 4D are views for explaining the organic nanofiber preparation step and the metal coating step according to the embodiment 1;

FIG. 5 is a view for explaining an organic nanofiber preparation step according to an embodiment 2;

FIG. 6 is a view for explaining an organic nanofiber preparation step according to an embodiment 3;

FIG. 7A to FIG. 7F are SEM photographs of metal-coated organic nanofibers before the metal nanostructure preparation step is preformed, and SEM photographs of nanostructures after the metal nanostructure preparation step is preformed;

FIG. 8A and FIG. 8B are an SEM photograph and a TEM photograph of a metal nanostructure after a metal nanostructure preparation step is performed with respect to a specimen 4;

FIG. 9 is an X-ray diffraction pattern chart of a metal nanostructure;

FIG. 10A to FIG. 10D are SEM photographs of a metal nanostructure when a metal nanostructure preparation step is performed while changing a heat treatment temperature with respect to a specimen 5;

FIG. 11A to FIG. 11D are SEM photographs of a metal nanostructure when a metal nanostructure preparation step is performed while changing a heat treatment temperature with respect to a specimen 6;

FIG. 12A to FIG. 12F are SEM photographs of a metal nanostructure when a metal nanostructure preparation step is performed while changing a heat treatment time with respect to a specimen 5;

FIG. 13 is an X-ray diffraction pattern chart of a metal nanostructure with respect to the specimen 5; and

FIG. 14 is an X-ray diffraction pattern chart of a metal nanostructure with respect to a specimen 6.

### DESCRIPTION OF THE PREFERRED EMBODIMENTS

Hereinafter, a method for manufacturing metal nanostructure and a metal nanostructure manufactured by the method are explained in conjunction with an embodiment shown in the drawing.

### Embodiment 1

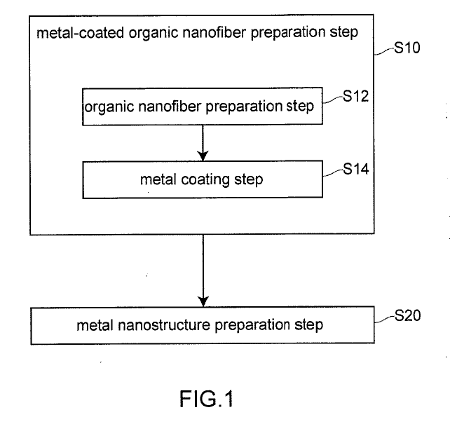

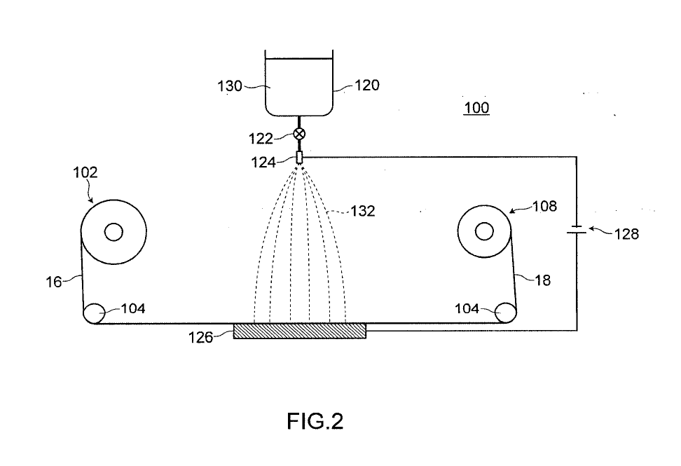

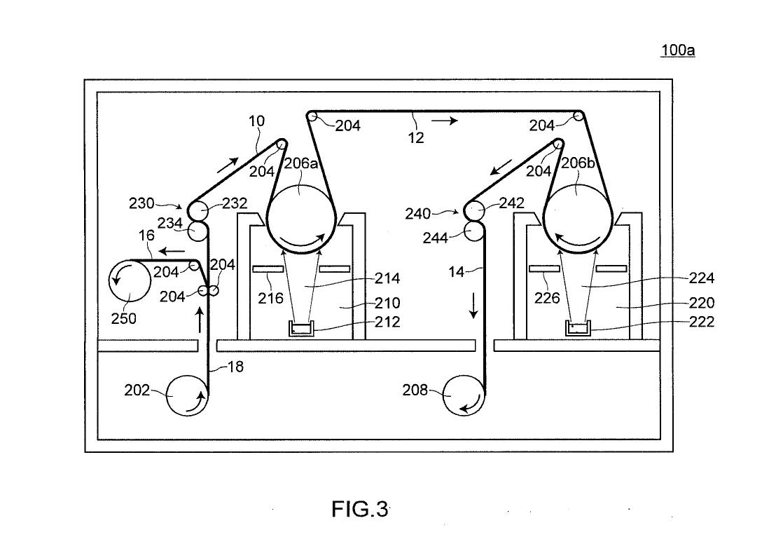

FIG. 1 is a flowchart for explaining a method for manufacturing metal nanofibers according to the embodiment 1. FIG. 2 is a view for explaining an organic nanofiber preparation step according to the embodiment 1. FIG. 3 is a view for explaining a metal coating step according to the embodiment 1. In FIG. 3, symbol 230 indicates a feed roller mechanism constituted of feed rollers 232, 234, symbols 206a, 206b indicate cooling rollers, symbols 210, 220 indicate vacuum vapor deposition chambers, symbols 212, 222 indicate vacuum vapor deposition units, symbols 214, 224 indicate metal vapors, and symbols 216, 226 indicate shield plates.

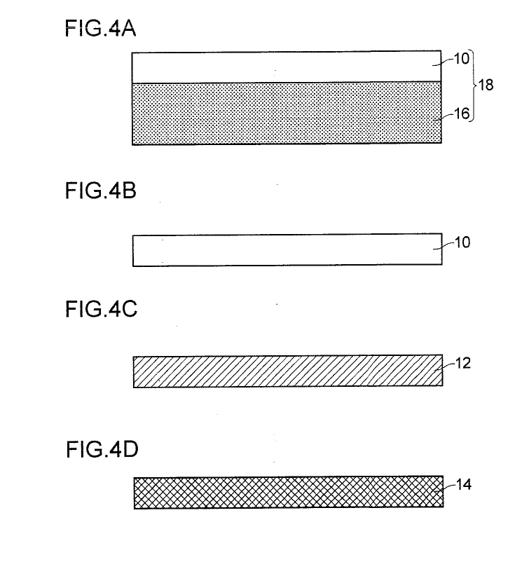

FIG. 4A to FIG. 4D are views for explaining the organic nanofiber preparation step and the metal coating step according to the embodiment 1, wherein FIG. 4A is a cross-sectional view of a laminated sheet 18 consisting of an elongated sheet 16 and an organic nanofiber nonwoven fabric 10, FIG. 4B is a cross-sectional view of an organic nanofiber nonwoven fabric 10 before being coated with metal, FIG. 4C is a cross-sectional view of a metal-coated organic nanofibers 12 in which one surface of the organic nanofiber nonwoven fabric 10 is coated with metal, and FIG. 4D is a cross-sectional view of a metal-coated organic nanofibers 14 in which another surface of the organic nanofiber nonwoven fabric 10 is also coated with metal

The method for manufacturing metal nanostructure according to the embodiment 1 includes, as shown in FIG. 1, a metal-coated organic nanofiber preparation step S10 and a metal nanostructure preparation step S20 which are performed in this order. Hereinafter, the method for manufacturing metal nanostructure according to the embodiment 1 is explained in accordance with the order of the steps.

1. Metal-coated organic nanofiber preparation step S10

The metal-coated organic nanofiber preparation step S10 is a step for preparing the metal-coated organic nanofibers in which surfaces of the organic nanofibers are coated with metal. As shown in FIG. 1, the metal-coated organic nanofiber preparation step S10 includes an organic nanofiber preparation step S12 (see FIG. 2 and FIG. 4A) and a metal coating step S14 (see FIG. 3 and FIG. 4B to FIG. 4D) which are performed in this order.

### 1-1 Organic Nanofiber Preparation Step S12

The organic nanofiber preparation step S12 is a step in which organic nanofibers are formed by electrospinning. In the organic nanofiber preparation step S12, as shown in FIG. 2, the organic nanofibers (layer thickness of 10 μm, for example, and average diameter of 300 nm, for example) are stacked on one surface of an elongated sheet 16 using an electrospinning device 100. The elongated sheet 16 is made of a nonwoven fabric of polyester fibers, for example. The formation of the organic nanofibers on the elongated sheet 16 is performed through the following steps.

Firstly, a polymer solution which is produced by dissolving polymer which is a raw material of organic nanofibers in a solvent is supplied to a raw material tank 120. As polymer which is the raw material of the organic nanofibers, for example, a polylactic acid (PLA), polypropylene (PP), polyethylene (PE), polyvinyl acetate (PVAc), polyethylene terephthalate (PET), polybutylene terephthalate (PBT), polyethylene naphthalate (PEN), polyamide (PA), polyurethane (PUR), polyvinyl alcohol (PVA), polyacrylonitrile (PAN), polyether imide (PEI), polycaprolactone (PCL), polylactic acid glycolic acid (PLGA), silk, cellulose, chitosan or the like can be used. It is possible to select optimum polymer depending on the usage.

Next, the elongated sheet 16 is paid off from a pay-off roll 102. At a point of time that the elongated sheet 16 passes above a collector 126 after passing a feed roller 104, a valve 122 is opened in a state where a high voltage is applied between a nozzle 124 and the collector 126 by a high voltage power source 128 so that a polymer solution 132 is jetted toward the elongated sheet 16 from the nozzle 124. The polymer solution 132 jetted from the nozzle 124 is formed into the organic nanofiber nonwoven fabric 10 on the elongated sheet 16. In this manner, a laminated sheet 18 constituted of the elongated sheet 16 and the organic nanofiber nonwoven fabric 10 is obtained. A thickness of the organic nanofiber nonwoven fabric 10 is 5 μm to 10 μm, for example. An average diameter of each one of the organic nanofibers which constitute the organic nanofiber nonwoven fabric 10 is 50 nm to 800 nm, for example. Thereafter, the laminated sheet 18 is wound around a winding roll 108 by way of a feed roller 104.

### 1. 2. Metal Coating Step S14

The metal coating step S14 is a metal coating step in which surfaces of the organic nanofibers are coated with metal. In the metal coating step S14, as shown in FIG. 4A to FIG. 4D, metal is vapor-deposited on both surfaces of the organic nanofiber nonwoven fabric 10 using a metal coating device 200 thus preparing metal-coated organic nanofibers 14.

The metal may be single element metal or an alloy. As single element metal, aluminum, copper, tin, zinc, nickel, chromium, titanium, silicon, lead, molybdenum, iron, gold, silver, platinum, palladium may be preferably exemplified. As an alloy, a copper-based alloy, an aluminum-based alloy, a titanium-based alloy, an iron-based alloy, a noble-metal alloy may be preferably exemplified. Metals which are vapor-deposited on both surfaces of the organic nanofiber nonwoven fabric 10 may be the same metal or different metals.

### 2. Metal Nanostructure Preparation Step S20

The metal nanostructure preparation step S20 is a step in which a metal nanostructure having the structure where the organic nanofibers are used as a template is formed by removing organic components from the metal-coated organic nanofibers 14 by heating the metal-coated organic nanofibers 14 at a temperature ranging from 250° C. to 600° C.

In the metal nanostructure preparation step S20, a ceramic-made crucible in which the metal-coated organic nanofibers 14 are put is placed in a heating region of a diffusion furnace and, thereafter, in a state where an inert gas such as a nitrogen gas is filled into the diffusion furnace, for example, a temperature of the heating region is elevated up to 400° C. under a condition of a temperature elevation speed of 5° C./min and, thereafter, the ceramic-made crucible is held at the same temperature for 10 hours. With such treatment, it is possible to prepare a metal nanostructure having the structure where the organic nanofibers are used as a template.

As the metal nanostructure having the structure where the organic nanofibers are used as the template, for example, a metal nanostructure made of metal nanotubes or a metal nanostructure made of metal nanochains may be exemplified, for example.

### 2. Advantageous Effects Acquired by the Method for Manufacturing Metal Nanostructure According to the Embodiment 1

According to the method for manufacturing metal nanostructure according to the embodiment 1, the metal nanostructure is formed by removing the organic components from the metal-coated organic nanofibers and hence, the metal nanostructure has the structure where the organic nanofibers are used as the template, that is, has the structure which does not exist conventionally and hence, it is possible to manufacture the metal nanostructure having properties different from properties of conventional materials.

The metal nanostructure manufactured by the method for manufacturing metal nanostructure according to the embodiment 1 is broadly applicable to fields such as various electronic/mechanical material fields (a semiconductor material, an OLED material, an LED material, a nano-chemical sensor material, an MEMS material, an FED material, a battery material such as a carrier of a fuel battery catalyst, an electromagnetic wave shield material, a bi-metal thermocouple material, a high-speed transistor material, a hydrogen gas storage material, a power storage device material, a transparent electrically conductive film material, an electrically conductive paste material, a magnetic material for a sensor, a memory or the like), a medical field material (a carrier of a biological sensor, a biomedical material, a medical MEMS, a medical micro robot, a regeneration medicine material or the like).

According to the method for manufacturing metal nanostructure according to the embodiment 1, it is possible to manufacture an extremely fine metal nanostructure (eventually having an extremely large surface area and an extremely large aspect ratio) using extremely fine organic nanofibers formed by electrospinning as the template.

Further, according to the method for manufacturing metal nanostructure according to the embodiment 1, it is possible to coat the surfaces of the organic nanofibers with various metals using a well-known metal vapor deposition technique.

Still further, according to the method for manufacturing metal nanostructure according to the embodiment 1, the metal is vapor-deposited on both surfaces of the organic nanofiber nonwoven fabric made of the organic nanofibers. Accordingly, compared to a case where metal is vapor-deposited on one surface of the organic nanofiber nonwoven fabric, a rate of portions to which metal is not vapor-deposited with respect to the whole organic nanofibers can be decreased and hence, it is possible to continuously and uniformly coat the surfaces of the organic nanofibers with metal.

Still further, according to the method for manufacturing metal nanostructure according to the embodiment 1, since the thickness of the organic nanofiber nonwoven fabric is 100 μm or less, compared to a case where the thickness of the organic nanofiber nonwoven fabric exceeds 100 μm, a rate of portions to which metal is not vapor-deposited with respect to the whole organic nanofibers can be decreased and it becomes possible to continuously and uniformly coat the surfaces of most of the organic nanofibers which constitute the organic nanofiber nonwoven fabric with metal.

Still further, according to the method for manufacturing metal nanostructure according to the embodiment 1, since an average diameter of the organic nanofibers is 1000 nm or less, compared to a case where the average diameter of the organic nanofibers exceeds 1000 nm, a rate of portions to which metal is not vapor-deposited with respect to the whole organic nanofibers can be decreased and it becomes possible to continuously and uniformly coat the surfaces of the organic nanofibers with metal.

The metal nanostructure according to the embodiment 1 is the metal nanostructure which is manufactured by the method for manufacturing metal nanostructure according to the embodiment 1 and hence, the metal nanostructure has the structure where the organic nanofibers are used as the template, that is, has the structure which does not exist conventionally (metal nanotube structure or metal nanochains structure) and hence, it is possible to manufacture the metal nanostructure having properties different from properties of conventional materials.

### Embodiment 2

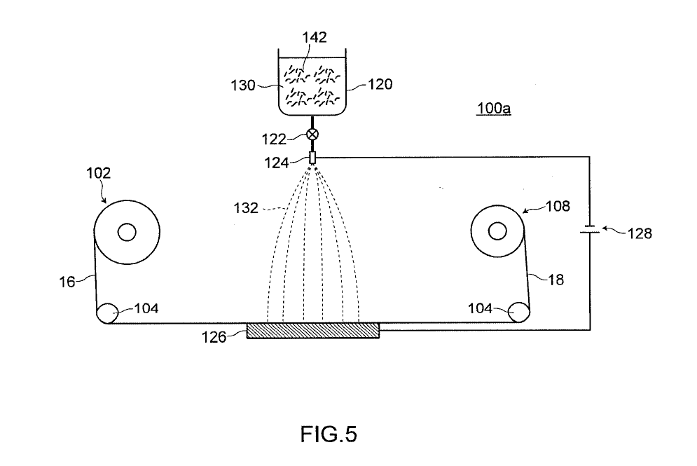

FIG. 5 is a view for explaining an organic nanofiber preparation step according to an embodiment 2. In FIG. 5, symbol 130 indicates a polymer solution, and symbol 142 indicates CNT.

The method for manufacturing metal nanostructure according to the embodiment 2 has the substantially same steps as the method for manufacturing metal nanostructure according to the embodiment 1 basically. However, the method for manufacturing metal nanostructure according to the embodiment 2 differs from the method for manufacturing metal nanostructure according to the embodiment 1 with respect to the content of the organic nanofiber preparation step. That is, in the method for manufacturing metal nanostructure according to the embodiment 2, as shown in FIG. 5, organic nanofibers which contain CNT in the inside thereof or on a surface thereof are formed by performing electrospinning using a polymer solution in which CNT is dispersed. As CNT, for example, multi-layered CNT (MWCNT) may be used.

In this manner, the method for manufacturing metal nanostructure according to the embodiment 2 differs from the method for manufacturing metal nanostructure according to the embodiment 1 with respect to the content of the organic nanofiber preparation step. However, in the same manner as the method for manufacturing metal nanofibers according to the embodiment 1, the metal nanostructure is formed by removing the organic component from the metal-coated organic nanofibers and hence, the metal nanostructure has the structure where the organic nanofibers are used as the template, that is, has the structure which does not exist conventionally and hence, it is possible to manufacture the metal nanostructure having properties different from properties of conventional materials.

Further, according to the method for manufacturing metal nanostructure according to the embodiment 2, the metal nanostructure has the structure where CNT is adhered to inner surfaces so that it is possible to manufacture the metal nanostructure which possesses properties different from properties of conventional materials.

The metal nanostructure according to the embodiment 2 has the structure where the organic nanofibers are used as a template (metal nanotube structure or metal nanochain structure) and CNT is adhered to inner surfaces so that it is possible to manufacture the metal nanostructure which possesses properties different from properties of conventional materials.

The method for manufacturing metal nanostructure according to the embodiment 2 has the substantially same steps as the method for manufacturing metal nanostructure according to the embodiment 1 except for the content of the organic nanofiber preparation step. Accordingly, the method for manufacturing metal nanostructure according to the embodiment 2 also possesses, out of all advantageous effects which the method for manufacturing metal nanostructure according to the embodiment 1 possesses, the advantageous effects brought about by the same steps as the method for manufacturing metal nanostructure according to the embodiment 1.

### Embodiment 3

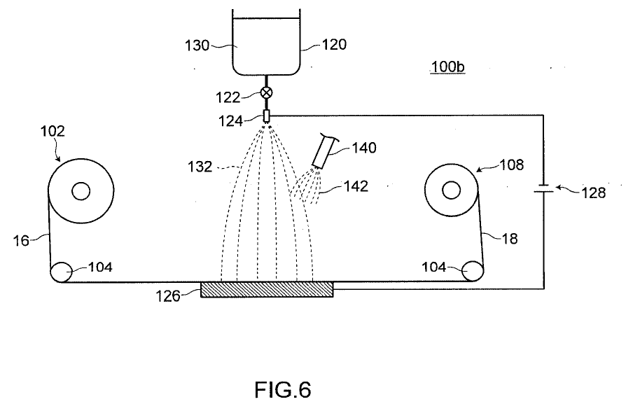

FIG. 6 is a view for explaining an organic nanofiber preparation step according to an embodiment 3. In FIG. 6, symbol 140 indicates CNT spraying device, and symbol 142 indicates CNT.

The method for manufacturing metal nanostructure according to the embodiment 3 has substantially same steps as the method for manufacturing metal nanostructure according to the embodiment 1 basically. However, the method for manufacturing metal nanostructure according to the embodiment 3 differs from the method for manufacturing metal nanostructure according to the embodiment 1 with respect to the content of the organic nanofiber preparation step. That is, in the method for manufacturing metal nanostructure according to the embodiment 3, as shown in FIG. 6, organic nanofibers to whose surface CNT is adhered are formed by performing electrospinning in such a manner that CNT 142 is sprayed from the CNT spraying device 140.

In this manner, the method for manufacturing metal nanostructure according to the embodiment 3 differs from the method for manufacturing metal nanostructure according to the embodiment 1 with respect to the content of the organic nanofiber preparation step. However, in the same manner as the method for manufacturing metal nanostructure according to the embodiment 1, the metal nanostructure is formed by removing the organic component from the metal-coated organic nanofibers and hence, the metal nanostructure has the structure where the organic nanofibers are used as the template, that is, has the structure which does not exist conventionally and hence, it is possible to manufacture the metal nanostructure having properties different from properties of conventional materials.

Further, according to the method for manufacturing metal nanostructure according to the embodiment 3, the metal nanostructure has the structure where CNT is adhered to inner surfaces so that it is possible to manufacture the metal nanostructure which possesses properties further different from properties of conventional materials.

Further, the metal nanostructure according to the embodiment 3 has the structure where the organic nanofibers are used as a template (metal nanotube structure or metal nanochain structure) and CNT is adhered to inner surfaces so that it is possible to manufacture the metal nanostructure which possesses properties different from properties of conventional materials.

The method for manufacturing metal nanostructure according to the embodiment 3 has the substantially same steps as the method for manufacturing metal nanostructure according to the embodiment 1 except for the content of the organic nanofiber preparation step and hence, the method for manufacturing metal nanostructure according to the embodiment 3 also possesses, out of all advantageous effects which the method for manufacturing metal nanostructure according to the embodiment 1 possesses, the advantageous effects brought about the same steps as the method for manufacturing metal nanostructure according to the embodiment 1.

### Example 1

Using a method substantially equal to the method for manufacturing metal nanostructure according to the embodiment 1, a metal nanostructure is manufactured. Here, polyvinyl alcohol (PVA, dissolved in distilled water, 12 wt %) is used as a raw material of organic nanofibers, and copper is used as metal.

Electrospinning is performed under a condition where a distance between a nozzle and a collector is set to 150 mm and an applied voltage is set to 8 to 10 kV. With such electrospinning, organic nanofibers having an average diameter ranging from 175 nm to 225 nm are obtained. Metal vapor deposition is performed using a metal vapor deposition device under a condition where a distance from a vapor deposition source to an elongated sheet is set to 400 mm. With such treatment, metal-coated organic nanofibers coated with copper having layer thicknesses of 50 nm, 100 nm and 200 nm respectively are obtained.

Among these metal-coated organic nanofibers, the metal-coated organic nanofibers (layer thickness: 100 nm) which are obtained by coating one surface of the organic nanofibers having diameter of 200 to 250 nm (average diameter: 225 nm) with copper are used as a specimen 1. The metal-coated organic nanofibers (layer thickness: 200 nm) which are obtained by coating one surface of the organic nanofibers having diameter of 200 to 250 nm (average diameter: 225 nm) with copper are used as a specimen 2. The metal-coated organic nanofibers (layer thickness: 200 nm) which are obtained by coating one surface of the organic nanofibers having diameter of 150 to 200 nm (average diameter: 175 nm) with copper are used as a specimen 3. The metal-coated organic nanofibers (layer thickness: 50 nm) which are obtained by coating both surfaces of the organic nanofibers having diameter of 200 to 250 nm (average diameter: 225 nm) with copper are used as a specimen 4.

Then, the specimens 1 to 4 are put into ceramic-made crucibles respectively and, thereafter, the ceramic-made crucibles are put into an electric furnace. The ceramic-made crucibles are heated up to 400° C. at a temperature elevation speed of 5° C./rain while allowing a nitrogen gas to flow through the electric furnace, and heating of the ceramic-made crucibles is held for 6 to 24 hours at such a temperature thus performing the metal nanostructure preparation step. With such treatment, the metal nanostructure is obtained with respect to the respective specimens 1 to 4.

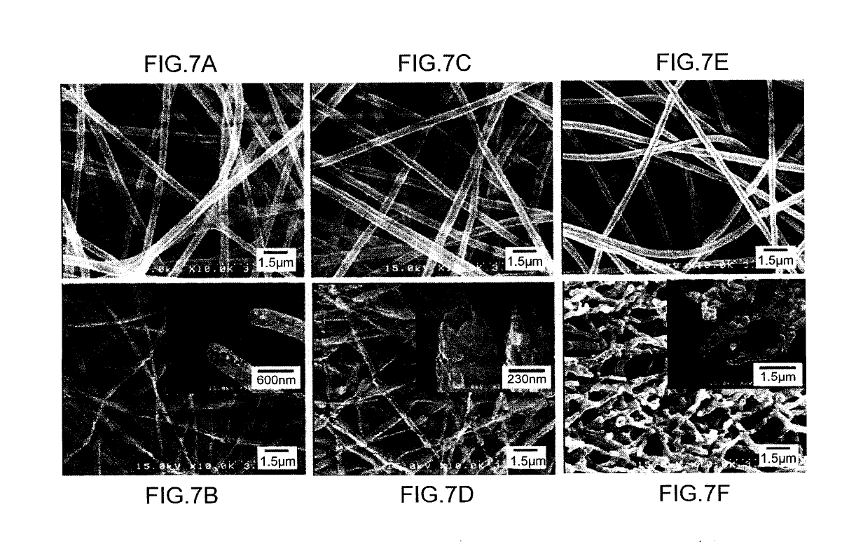

FIG. 7A to FIG. 7F are SEM photographs of metal-coated organic nanofibers, wherein FIG. 7A, FIG. 7C and FIG. 7E are the SEM photographs of metal-coated organic nanofibers the before the metal nanostructure preparation step is preformed, and FIG. 7B, FIG. 7D and FIG. 7F are the SEM photographs of the metal nanostructure after the metal nanostructure preparation step is preformed. FIG. 7A and FIG. 7B are the SEM photographs of the specimen 1, FIG. 7C and FIG. 7D are the SEM photographs of the specimen 2, and FIG. 7E and FIG. 7F are the SEM photograph of the specimen 3.

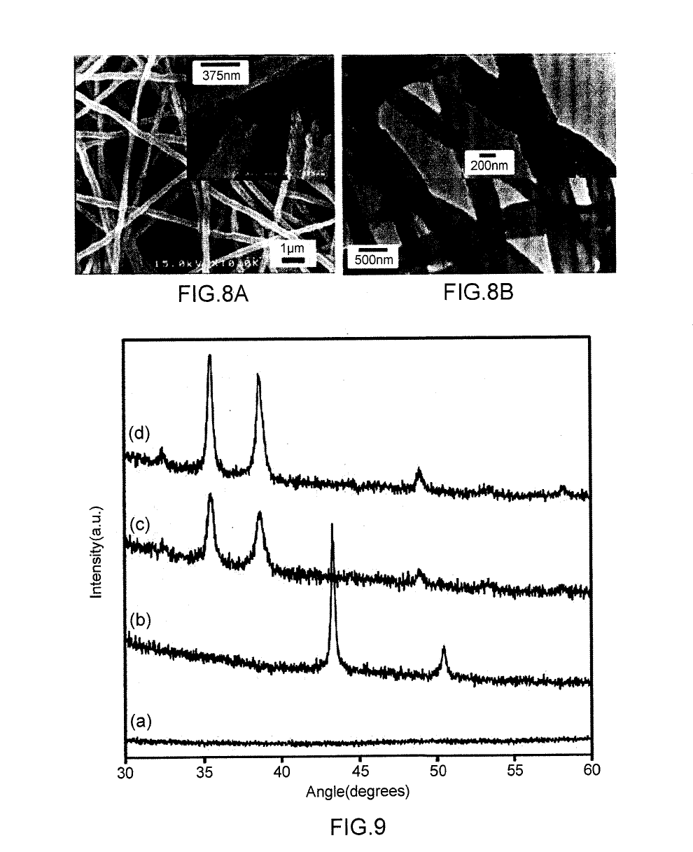

FIG. 8A and FIG. 8B are a SEM photograph and a TEM photograph of a metal nanostructure respectively after a metal nanostructure preparation step is performed with respect to the specimen 4. That is, FIG. 8A is the SEM photograph of the metal nanostructure, and FIG. 8B is the TEM photograph of the metal nanostructure.

As a result, as can be understood from FIG. 7A to FIG. 7E and FIG. 8A and FIG. 8B, it is confirmed that the metal nanostructure having the structure where organic nanofibers are used as a temperate is formed with respect to all specimens 1 to 4.

Further, as can be also understood from FIG. 7B, FIG. 7D and FIG. 7F, and FIG. 8A and FIG. 8B, it is confirmed that the metal nanotubes are formed with respect to the specimen 1, the specimen 2 and the specimen 4, while metal nanochains are formed with respect to the specimen 3.

Further, as can be also understood from FIG. 8A and FIG. 8B, it is confirmed that since metal is deposited on both surfaces of the organic nanofibers with respect to the specimen 4, the metal nanostructure which has a metal vapor deposition film on the whole surface thereof uniformly is formed.

FIG. 9 is an X-ray diffraction pattern chart of a metal nanostructure. In FIG. 9, symbol (a) indicates an X-ray diffraction pattern of organic nanofibers, symbol (b) indicates an X-ray diffraction pattern of metal-coated organic nanofibers before the metal nanostructure preparation step is performed with respect to the specimen 2, symbol (c) indicates an X-ray diffraction pattern of the metal nanostructure after the metal nanostructure preparation step is performed with respect to the specimen 1, and symbol (d) indicates an X-ray diffraction pattern of the metal nanostructure after the metal nanostructure preparation step is performed with respect to the specimen 2.

As can be understood also from FIG. 9, the existence of copper is observed in the metal-coated organic nanofibers, and the existence of an oxide of copper (CuO) is confirmed in the metal nanostructure. Accordingly, it is confirmed that the metal nanostructure is constituted of an oxide of copper.

### Example 2

Using a method substantially equal to the method for manufacturing metal nanostructure according to the embodiment 1, a metal nanostructure is manufactured. Here, polyurethane (PU, dissolved in DMF, 14 wt %) is used as a raw material of the organic nanofibers, and a copper nickel alloy is used as metal. Metal nanostructures are formed by changing a content ratio between copper and nickel in the copper nickel alloy to 9:1 (specimen 5) or 4:6 (specimen 6), and the heat treatment temperature (250° C., 400° C., 600° C.) and the heating time (6 hours, 12 hours and 24 hours) in the metal nanostructure preparation step respectively, and a surface state of the metal nanostructures are observed. The heat treatment is performed while allowing a nitrogen gas to flow through an electric furnace.

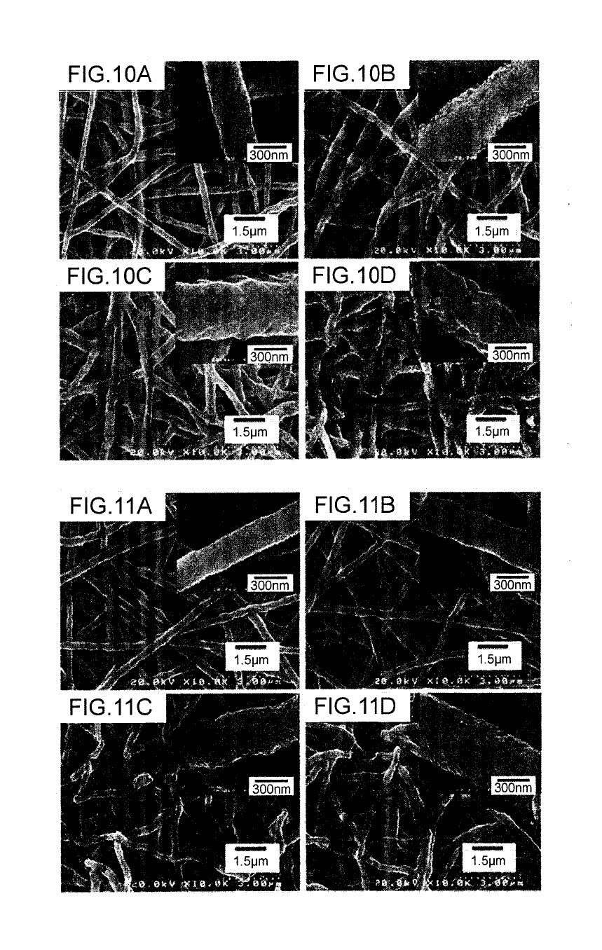

FIG. 10A to FIG. 10D are SEM photographs of a metal nanostructure when a metal nanostructure preparation step is performed while changing a heat treatment temperature with respect to a specimen 5. FIG. 10A is the SEM photograph of the metal-coated organic nanofibers before the metal nanostructure preparation step is performed, and FIG. 10B, FIG. 10C and FIG. 10D are the SEM photographs of metal nanostructure after the metal nanostructure preparation step is performed. Here, FIG. 10B is the SEM photograph of the metal nanostructure when heat treatment is performed at a temperature of 250° C. for 12 hours, FIG. 10C is the SEM photograph of the metal nanostructure when heat treatment is performed at a temperature of 400° C. for 12 hours, and FIG. 10D is the SEM photograph of the metal nanostructure when heat treatment is performed at a temperature of 600° C. for 12 hours.

FIG. 11A to FIG. 11D are SEM photographs of a metal nanostructure when a metal nanostructure preparation step is performed while changing a heat treatment temperature with respect to a specimen 6. FIG. 11A is the SEM photograph of the metal-coated organic nanofibers before the metal nanostructure preparation step is performed, and FIG. 11B, FIG. 11C and FIG. 11D are the SEM photographs of metal nanostructure after the metal nanostructure preparation step is performed. Here, FIG. 11B is the SEM photograph of the metal nanostructure when heat treatment is performed at a temperature of 250° C. for 12 hours, FIG. 11C is the SEM photograph of the metal nanostructure when heat treatment is performed at a temperature of 400° C. for 12 hours, and FIG. 11D is the SEM photograph of the metal nanostructure when heat treatment is performed at a temperature of 600° C. for 12 hours.

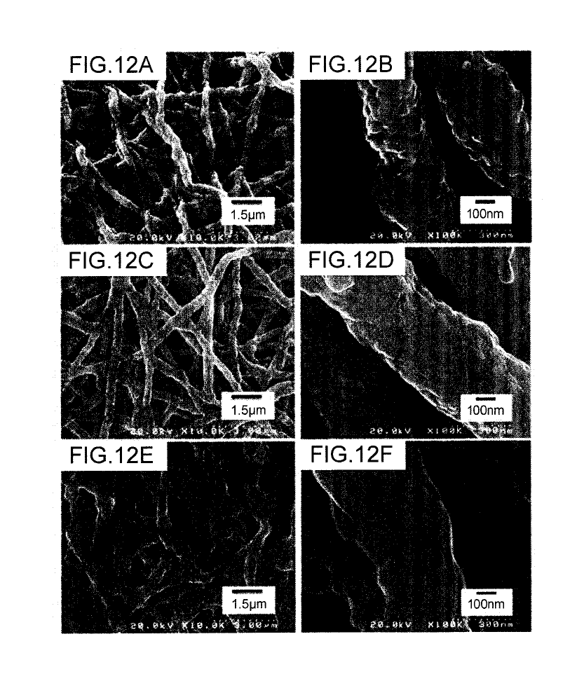

FIG. 12A to FIG. 12F are SEM photographs of a metal nanostructure when a metal nanostructure preparation step is performed while changing a heat treatment time with respect to a specimen 5. FIG. 12A and FIG. 12B are the SEM photographs of the metal nanostructure when heat treatment is performed at a temperature of 400° C. for 6 hours, FIG. 12C and FIG. 12D are the SEM photographs of the metal nanostructure when heat treatment is performed at a temperature of 400° C. for 12 hours, and FIG. 12E and FIG. 12F are the SEM photographs of the metal nanostructure when heat treatment is performed at a temperature of 400° C. for 24 hours.

As a result, as can be also understood from FIG. 10A to FIG. 12F, it is confirmed that the metal nanostructure having the structure where organic nanofibers are used as a temperate is formed with respect to the specimens 5 to 6.

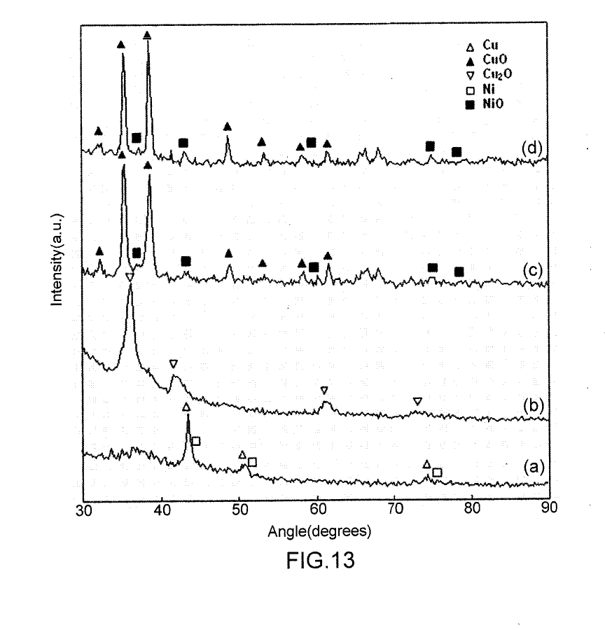

FIG. 13 is an X-ray diffraction pattern chart of a metal nanostructure with respect to the specimen 5. In FIG. 13, symbol (a) indicates an X-ray diffraction pattern of metal-coated organic nanofibers before the metal nanostructure preparation step is performed, and symbols (b), (c) and (d) indicate X-ray diffraction pattern of the metal nanostructure after the metal nanostructure preparation step is performed. Here, FIG. 13(b) is the X-ray diffraction pattern of the metal nanostructure when the heat treatment is performed at a temperature of 250° C. for 12 hours, FIG. 13(c) is the X-ray diffraction pattern of the metal nanostructure when the heat treatment is performed at a temperature of 400° C. for 12 hours, and FIG. 13(d) is the X-ray diffraction pattern of the metal nanostructure when the heat treatment is performed at a temperature of 600° C. for 12 hours.

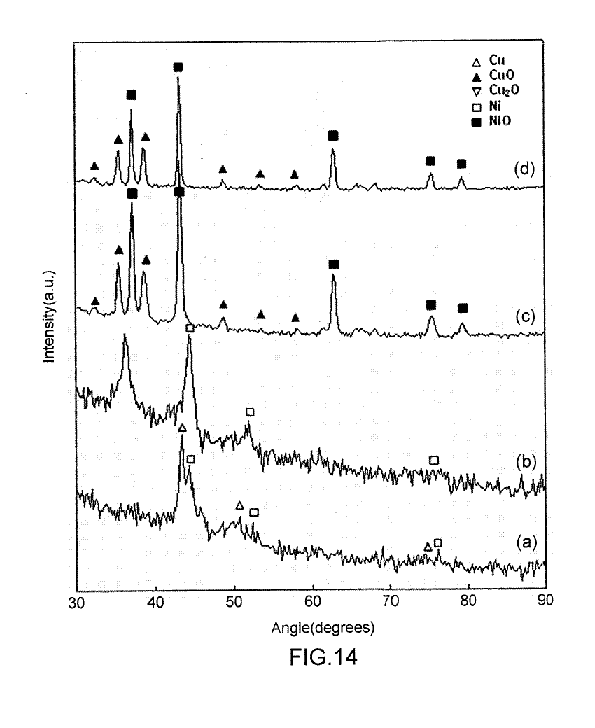

FIG. 14 is an X-ray diffraction pattern chart of a metal nanostructure with respect to the specimen 6. In FIG. 14, symbol (a) indicates an X-ray diffraction pattern of metal-coated organic nanofibers before the metal nanostructure preparation step is performed, and symbols (b), (c) and (d) indicate X-ray diffraction patterns of the metal nanostructure after the metal nanostructure preparation step is performed. Here, FIG. 14(b) is the X-ray diffraction pattern of the metal nanostructure when the heat treatment is performed at a temperature of 250° C. for 12 hours, FIG. 14(c) is the X-ray diffraction pattern of the metal nanostructure when the heat treatment is performed at a temperature of 400° C. for 12 hours, and FIG. 14(d) is the X-ray diffraction pattern of the metal nanostructure when the heat treatment is performed at a temperature of 600° C. for 12 hours.

As a result, as can be also understood from FIG. 13 and FIG. 14, the existence of metal (copper and nickel) is observed in the metal-coated organic nanofibers, and the existence of oxides (an oxide of copper and an oxide of nickel) is confirmed in the metal nanostructure. Accordingly, it is confirmed that the metal nanostructure is constituted of an oxide of copper.

Although the method for manufacturing metal nanostructure and the nanostructure manufactured by the method according to the present invention have been explained heretofore in conjunction with the above-described embodiments, the present invention is not limited to the embodiments, and various modifications and variation can be carried out without departing from the gist of the present invention.

(1) The metal nanostructure is manufactured using copper as metal in the example 1, and the metal nanostructure is manufactured using the copper-nickel alloy as metal in the example 2. However, the present invention is not limited to these examples, and it is possible to manufacture the metal nanostructure using various metals and various alloys besides copper and the copper-nickel alloy.

(2) In the example 1 and the example 2, the metal nanostructure made of a metal oxide is manufactured. However, the present invention is not limited to these examples, and a metal nanostructure made of metal can be manufactured by performing heat treatment under a condition where the intrusion of oxygen is completely interrupted.

(3) The organic nanofibers are formed using polyvinyl alcohol in the example 1, and the organic nanofibers are formed using polyurethane in the example 2. However, the present invention is not limited to these examples, and the organic nanofibers can be formed by using a polymer other than polyvinyl alcohol and polyurethane.

1. A method for manufacturing metal nanostructure comprising the steps of:
preparing metal-coated organic nanofibers in which surfaces of the organic nanofibers are coated with metal; and
preparing a metal nanostructure having the structure where the organic nanofibers are used as a template by removing organic components from the metal-coated organic nanofibers by heating the metal-coated organic nanofibers at a temperature ranging from 250° C. to 600° C.

2. The method for manufacturing metal nanostructure according to claim 1, wherein the step of preparing the metal-coated organic nanofibers comprises the step of:
preparing the organic nanofibers by electrospinning; and coating surfaces of the organic nanofibers with metal.

3. The method for manufacturing metal nanostructure according to claim 2, wherein in the step of coating the surfaces of the organic nanofibers with the metal, the metal is vapor-deposited on the surfaces of the organic nanofibers.

4. The method for manufacturing metal nanostructure according to claim 3, wherein in the step of coating the surfaces of the organic nanofibers with the metal, the metal is vapor-deposited on both surfaces of an organic nanofiber nonwoven fabric made of the organic nanofibers.

5. The method for manufacturing metal nanostructure according to claim 4, wherein a thickness of the organic nanofiber nonwoven fabric is 100 μm or less.

6. The method for manufacturing metal nanostructure according to claim 5, wherein an average diameter of the organic nanofibers is 1000 nm or less.

7. The method for manufacturing metal nanostructure according to claim 1, wherein the organic nanofibers are formed of organic nanofibers each of which contains carbon nanotubes therein.

8. The method for manufacturing metal nanostructure according to claim 1, wherein the organic nanofibers are formed of organic nanofibers having surfaces to which carbon nanotubes are adhered.

9. A metal nanostructure which is manufactured by the method for manufacturing metal nanostructure according to claim 1, wherein the metal nanostructure is formed of metal nanotubes or metal nanochains.

10. The metal nanostructure which is manufactured by the method for manufacturing metal nanostructure according to claim 7, wherein the metal nanostructure is formed of metal nanotubes or metal nanochains, and carbon nanotubes are adhered to inner surfaces of the metal nanotubes or inner surfaces of the metal nanochains.
